(19) United States
(12) Patent Application Publication
(10) Pub. No.: US 2014/0281889 A1
(43) Pub. Date: Sep. 18, 2014

(54) RESEARCH DATA COLLECTOR AND ORGANIZER (RDCO)

(71) Applicant: Varda Treibach-Heck, Foster City, CA (US)

(72) Inventor: Varda Treibach-Heck, Foster City, CA (US)

(21) Appl. No.: 13/831,838

(22) Filed: Mar. 15, 2013

(51) Int. Cl. G06F 3/0484

(52) U.S. Cl. CPC G06F 3/0484
USPC 715/234; 715/771

(57) ABSTRACT

A data source, such as a web page, a locally retrieved document, user-entered information, etc., is made visible to a user via a display, such as a computer monitor or touch-screen tablet or smart phone screen. The user selects data of interest from the display and indicates its type to a collection routine, which runs either overlaid onto the frame as a template being viewed by the user, or in the background. The collection routine then automatically associates the data with the corresponding field of a database. A later user may then view not only the current data record, but others, so as to see an organized compilation of information from multiple data sources. The collection routine may also enable multi-user and multi-source input.

### FIELD OF THE INVENTION

This invention relates to a method and system for the collecting and organizing of data from web sites, web, phone and tablet applications or other installed and/or client-server and/or internet-based software programs, which allows for easy searching and retrieval, as well as collection and organization of observed and/or unobserved data.

### BACKGROUND

Significant research is done on the internet, either through open web-addressable content, web, mobile and client-side applications, through subscriptions or in other ways. Computers, phones, tablets, PDAs (personal digital assistants) and other electronic devices are of course commonly used to do this research. Research often involves multiple sources and when the screen size allows, multiple screens. Research is done for work and pleasure, for personal use and out of necessity. Some examples of the innumerable types of research conducted every day include shopping for a product, medical research, finding people, comparing candidates (such as when hiring), patent research, comparing dentists or physicians, problem-solving, knowledge seeking, literature searching, etc. Because of the vast amount of information available on the internet, virtually all research is now done wholly or partially online.

Often when doing research of almost any kind, the researcher wants to keep track of what was seen, where value was found, where there may be a resource for later use, where time was wasted, etc. For example, if a researcher is researching mobile phones with the intent of purchasing one, she may want to compare screen size, weight, features, appearance, accessories, phone service availability, etc. Some of these sites may, moreover, be useful to revisit when the researcher decides to buy a tablet computer and wants to make sure all the electronics work harmoniously together.

Another example would be doing online research about different physicians. For example, perhaps one has just moved to a new city and needs to choose a new primary doctor or specialist. One would want to compare factors such as years of experience, location, schools attended, specialties, insurance accepted, perhaps languages spoken, reviews and complaints (such as on Yelp, or through the American Medical Association or Better Business Bureau, for example), perhaps the physicians' interests, even the physicians' appearance if the researcher wanted a provider of the same sex or a younger practitioner for new approaches or an older practitioner for years of experience. The researcher may come across names or fields of practice that are not needed at the moment, but may be needed in the future. Bookmarking a page is ineffective and inconvenient if the page content changes. What is needed is a single window data capture mechanism that does not slow down the user but memorializes the search process and grabs the data as it is indicated to have value. Currently, it is not possible to capture this information and organize it in a way that is easy to use, sort, filter, store and share. One might select, cut, and paste information from a web site into a Word document or Excel document, but this is tedious and time-consuming and requires a split screen and/or switching back and forth between applications. If the data captured were organized into columns, the number of columns or number of features being researched becomes a hindrance and significant time-taker. Copying images and HTML into client-side software also may cause formatting and functionality problems. Using existing software and methods, the search process is often disorganized, and there is often no way of managing multiple people doing research on the same topic. For example, if there were four Human Resource professionals all looking for suitable candidates for the same job, who all posted their curricula vitae on different websites, there is currently no good way of managing this process, including organizing the resulting data, keeping track of the discards and making sure the researchers are not looking at the same candidates and duplicating each others' efforts.

Currently, if an online researcher wants to create a report of her findings, she needs to create that report herself from scratch, using a word processing or other document. This requires a lot of custom formatting and may not even be possible if the report needs to include images, documents, or large blocks of text (such as source code, or long links etc).

Some web sites allow the user to click a “compare” box and compare several products, such as cell phones. This is helpful, but data compared may or may not be the data that the user wants to compare. Also, there is usually a limit of four or five items that can be compared at one time. A solution is needed which allows a user to research information in multiple web sites or applications and easily manage, save, organize and retrieve the data collected.

### BRIEF DESCRIPTION OF THE DRAWINGS

FIGS. 1-7 show sample researcher screens.

FIGS. 8-17 show sample customer/designer screens

FIG. 18 illustrates a system that implements various embodiments of the invention.

### DETAILED DESCRIPTION

Merely for the sake of succinctness, the system that implements the various common and optional aspects of different embodiments of this invention is referred to as the “Research Data Collector and Organizer (RDCO system)” system. As is described in greater detail below, the RDCO system here solves the problems associated with researching several different, and unrelated, web sites and/or software applications. The RDCO system allows a researcher to layer an interface on top of any web site or software application, which allows the user to easily collect information, store the information in the RDCO system, and review and organize the information in a flexible report for later use. If desired, the data can also be mapped, formatted and exported into other software systems.

The RDCO system may be configured to collect and store all data types, including, but not limited to data items such as formatted or unformatted text, SMS, chats, emails, faxes, screenshots, images, source code, videos, documents, form field inputs, URL or location, time accessing the site, time on the site, user, whether data is collected, in short: any data item that is information in digital form that is presented to a user in such a way that the user can select it for storage. The data may be collected in an easy, and sometimes even automatic, manner. For example, the URL, user, time accessing a site, source code, screenshot, etc. can be collected without the researcher doing anything since this information is available to software from the browser and operating system. Other data items may be collected easily, using known selection techniques such as copy-and-paste, drag-and-drop, a simple button, indicative HTML elements and manual entry.

The RDCO system may overlay a single web site or application that it is accessing for searching or collecting data items or multiple screens or sources so that it forms a single frame on the screen. The overlay may optionally be associated with a particular template chosen as being suited for the current search criteria. Common templates may be pre-configured and made available, or could be customized or created from scratch. The overlay may be opaque, transparent or semi-transparent, and either fixed or minimize-able. The RDCO system may be a parent frame, where the researched web site or application is a child frame. Ideally, for convenience, the RDCO system and the web site or application being researched are on the same screen and visible at the same time, making data collection much easier, especially on small-screen devices such as tablets and phones.

The RDCO system may have several functional levels and several user types with different roles. For example, the RDCO system may manage pre-existing templates, customized templates and projects. User types may include a designer role, a researcher role and a report reader role. Other roles may exist, such as customer, and these roles may overlap or totally coincide.

As used here, “templates” are configured sets of data collection fields configured either by the RDCO system or by a customer or administrator/designer. A custom template is a customized set of data collection fields that are set up by the designer. The designer may create a customized template from a pre-existing template, or may create a customized template from scratch. A customized template can also serve as a starting point, or a template, for future templates. A project is a set of one or more templates. The “designer” is the user type who sets up the customized templates and, possibly, a project. The “researcher” is the user type who collects data by interacting with the data label portion of the template. The report “reader” is the user type who ultimately uses the data collected within a template, or project.

Privileges are generally set by the designer at the template level. Privileges may be set at other levels as well. Data is collected by the researcher at the template level. The data may then be stored in a database for storage, retrieval and reporting. The database is preferably unstructured, or open, so that it can store different data types easily. However, the database can be any common or commercially available database. The database can be separated from the user-layer software or can be fully integrated.

The data can be exported and/or encoded, for example, using Extensible Markup Language (XML), XML-based formats or other open standards markup language or schema systems for the representation of arbitrary data structures over the Internet so that the data can be used in a form, a web service or a configuration file for processing, or used in any other suitable way, after entry into a database.

By using the RDCO system, the researcher is able to quickly and easily collect useful data from a variety of disparate and separate sources so that the data can be used, for example, to further business objectives or help make personal or other decisions. For example, if a person wants to research different cell phone options, she can open the RDCO system and then indicate what template she wants to use and then visit the sites/applications she wants to research. For example, she may want to go to various web sites of cell phone manufacturers and service providers. She may be interested in specific features, such as cost, service provider, dimensions, appearance, camera resolution, weight, screen size, battery life, etc. To do this using the RDCO system, the user would navigate to these various sites within the RDCO system, and find the pertinent info for the various cell phone models. The RDCO system then allows her to easily enter (by copying-and-pasting, dragging-and-dropping or other known manual entry or selection methods) this info into the RDCO system, and ultimately into, the RDCO system database. The database may then include all the information for each of the phone models in which the user is interested. The database may also include the Uniform Resource Locators, or URLs, from which the user collected data and the URLs from which she did not collect data. In other words, the RDCO system may, if this option is selected, keep track of everywhere the user visits, as well as whether the visit was productive or not. This feature, if implemented, would inform the user to avoid visiting sites where she did not find useful information.

The resulting data can then be either exported or displayed to the user in any meaningful way. For example, the user may want to see the information presented in a spreadsheet or chart form which she can search, sort, and otherwise manipulate the data to her liking. The user may also want to export the data into another application for further analysis. The user may also want to allow another person to view the report, either on the web, on their phone, via email or by other means.

The various aspects—common and/or optional—of the RDCO system are described below in greater detail with reference to an example of an embodiment that is shown in the figures.

The RDCO system may have several functional levels and several user types with different roles, as mentioned above. For example, the designer may perform the traditional functions of an administrator, and may also set up a new data collection project and assign users access to it as well as choose, customize and identify access privileges for the project. The designer preferably also defines what data is to be collected and assigns any rules to the data collection process, such as which data is required and which is optional. The designer may also create the report format(s), possibly by dragging and dropping collection field buttons into columns and determining filter criteria for the reports. There may also be a customer, a researcher, and a report reader, as well as other possible user types, as described above.

As used here, the “customer” will generally be the user who directs and oversees the project. The customer can also be the designer, but preferably with the power to remove a designer from a project once it has been created. For example, a customer/designer might be a recruiter who has several subordinate recruiters. She may then want data collected on different candidates for an open position. She, as a customer/designer, may then set up a new data collection project and assign users access to it. She can define what data she wants collected and assign any rules to the data collection process, such as which data are required and which are optional. The customer also has access to, and control of, the data as it is being collected. For example the customer may be able to view reports of the data as it is being collected, as well as who is collecting the data and how quickly. The customer/designer can also add researchers and report readers and define their privileges.

Alternatively, the customer role and designer role may be separate: The customer may direct the designer to set up the project in a certain way and simply review the results. In this case, the designer would be responsible for setting up customized templates and projects as well as, depending on the situation, for setting up privileges.

The researcher is the user who collects the data. There may be any number of researchers on a project, including only one. The researcher may or may not have access privileges to add new data which is to be collected. For example, if the researcher has these privileges, and notices that several of the recruiting candidates she is researching for an open position have interesting hobbies, she may add a data field to the project, on the fly, by simply creating a label, “Hobbies”. If this happens, the customer may be alerted and may be required to approve the addition. The researcher may or may not have access privileges as a report reader to the project reports or be able to edit data that has previously been collected and is present in the reports

The report reader is the user who ultimately reviews the results of the research project. In many instances, the report reader may be the same user as the customer. However, the customer may want to give report-reading privileges to others, including researchers, or other individuals. In the example of a recruiter evaluating candidates, the project customer may want to give report-reading privileges to the client doing the hiring. The customer may also give the report reader access to only a portion of the data. In this case, the customer would customize the reports and control who accesses which reports.

FIG. 1 shows screen 100 of one possible embodiment of the RDCO system and represents what a research user type might see after logging in and choosing a research project and template (if she is assigned to more than one) and going to a website for research. Keep in mind that the lay-out and data and information fields of the example illustrated in the figures are purely by way of example—designers of different research projects will of course typically prefer different templates. User and Template and Project info 112 is shown at the top left. In this illustration, the research project is called “Find Doctor” and the custom template is Dr. custom, the user's name is Jane Smith. There are two primary screen areas, or frame areas shown: 102 and 104. Screen area 102 is controlled by the RDCO system and may be made scrollable to be as long as necessary to house the data fields (scroll not shown, but well know to application designers). Screen area 104 is controlled by the site or application from which the researcher is collecting data. In other words, screen area 104 may in most cases be the window that the user's selected browser displays for the web page the user has navigated to or otherwise found. Screen area 104 may, moreover, be a web site in a frame (such as for the example web site FindAGoodDoc.com) within frame 102, which may in turn be a web site (illustrated as www.researchdatacollectorganizer.com) used to implement the RDCO system itself, or within a displayed frame created by a client-based application that implements the RDCO system locally for later data export.

In this sample screen, the web site being researched is called FindAGoodDoc.com. In this example, the researcher is collecting information relating to different doctors. There is information on the FindAGoodDoc.com web site includes such typical fields as doctor Name 116, Specialty 118, Image 130, general information 124, Address 120, Phone number 122, downloadable Document 126 and a form field 128 in which the user can enter data manually, in this case, a proximity preference indicator such as a Zip code. RDCO system screen area, or frame 102, includes buttons 106 where each data item being collected corresponds to a data label having the appearance of a button and where each data label represents a different data fieldbeing collected in the database; and indicators 108 (shown as check marks) that indicate which fields have been collected and which have not, Form field 110, which in this example is a text box for Notes, and tabs 114, which, in this example, allow the user to toggle back and forth between data collection mode and a report mode. A Send email button 132 is illustrated to indicate an option to allow the user to send an email from the screen. For example, the user may want to send thoughts about important data collected from a particular web site immediately to the customer for the project.

Different elements on the RDCO system screen area may be made visible or not visible depending on how the template was set up by its designer. For example, here, buttons 106 and form field 110 represent some of the data fields the customer/designer has specified as important for the project: Name, Address, Phone, Specialty, Image, Import/Insert, Screenshot, Document, Source, and Notes. Other data for “hidden” fields (such as system time and the current URL FindAGoodDoc.com, etc.) may be collected automatically, and, as a result, may not need to be displayed and are therefore not visible in this example. Some of these fields may be required by the project, and some may be optional. Whether the field is required may be indicated by color or other graphical indicators.

FIG. 2 shows the same researcher screen as FIG. 1 where the specialty “Primary Care” has been highlighted or indicated or otherwise selected. Highlighting a word or area can be done in any known manner, such as by using a selecting device to slide the cursor over the word while holding down a button, single clicking, double clicking, left or right clicking, hovering over the area, using a finger or stylus, mouse, or other selecting devices. A highlighted word, phrase or area may or may not show shading as shown in FIG. 2. For example, a single click may show only a cursor, some other indicator, or nothing at all. Selection of features in a displayed screen is a well-known operation and any preferred method(s) may be specified and implemented. Here, for convenience, all such methods and areas are simply referred to as “selection” or “selecting” and as being “selected”.

Once an area has been selected, the user may want to enter the information into the RDCO system. In FIG. 2 this is done by identifying the selected area 118, and then using the mouse or other pointer to click the appropriate entering mechanism or button or selecting device 202, which in this case is labeled “Specialty”. In doing so, the text “Primary Care” will be entered into the RDCO system in the “Specialty” field, indicated and controlled by input feature 202, which may be any desired graphical or text-input tool such as a button, a link, a text box, select list, etc.

Associating selected data with any of the data labels/input and collection fields 106 may be accomplished in any of many different ways. For example, assume the user has selected “Primary Care” and wants to associate it with “Specialty”, such that “Primary Care” is entered into the database as the specialty for Dr. John Doe, MD. One way would be to select the text and then to click on the “Specialty” button, as mentioned above. Another way would be to select the data item (“Primary Care”) and then “drag” this to the “Specialty” button.

It would also be possible to display a temporary drop-down menu after “Primary Care” is selected, with selectable options corresponding to the data label buttons 106; the user could then select which field to associate the selected data with. One disadvantage of this method is that it may obscure too much of the screen during the process; moreover, it would in many cases be redundant given the “active” buttons 106. Nonetheless, such alternative association methods may be useful in some implementations and fall within the scope of what a skilled system designer might consider.

An example of one such implementation in which it may be preferred not to have a fixed, visible display of the RDCO frame 102, or at least the template “label”/collection area/button 106, along with the frame(s) showing the data source(s) would be in the cases where the user is using a device such as a smart phone or tablet, with limited viewing area. Displaying all the information in both areas 102 and 104 might in such a case make it difficult to view everything at once, requiring frequent zooming, scrolling and sliding of the total display. If, after or before data item selection, the various entry fields 106 are instead presented to the user in the form of a drop-down menu, pop-up tool, or similar temporary graphical input tool, more of the limited display screen could be devoted to the active data source frame 104, thereby allowing the RDCO utility to remain wholly or partially “invisible” to the user while still having full functionality. Of course, this variation could also be implemented even on large displays. It would also be possible, using normal techniques, to allow the user to “toggle” between the RDCO frame 102 and the current data source frame 104, which would make it easier for the user to see, for example, the data presence indicators 108 or click or other RDCO control icons.

The system could also work in reverse, such that the user first selects the data label from the RDCO system, and then selects the research area that is to be associated with it. For example, the user could click on the data label/button (for example) 202 to select “Specialty” and then select the data item “Primary Care” in area 118. In either case, the data may be entered into the database at this point or reside in a buffer to be entered into the database later.

Local buffering of collected data may also be used to enable an “offline” or “real-time-updating” embodiment. In this embodiment, the RDCO system, which may be configured as a standard application or as an agent, sends buffered data to the project database when triggered to do so. One form of trigger event is that the user has completed the association of a data item with a data label; another could be that the user selects an RDCO control such as “commit” or “upload” or “finished” icon (displayed, for example, anywhere desired in the frame 102), or simply when the user exits the RDCO system. Another form of uploading trigger could be any edit to the data associated with the fields 106; this would implement a form of “synch-ing” with the remote database, as is found in some other commonly used applications. Another trigger could be time lapse or a time interval, according to some predetermined schedule, such as at the end of a day or hour, or more frequently if the amount of buffered data exceeds some threshold.

In one embodiment, the RDCO system may auto-format data for more logical data entry. For example, a user may select a full name, such as “Dr. John Doe, MD”. When the user enters this information into the RDCO system, by clicking a button or otherwise, the RDCO system may automatically break the text down into the following fields: Prefix, First Name, Middle Name, Last Name, Suffix, etc. Skilled programmers will know how to implement such “intelligent” data extraction/organization such that the RDCO system will know which part of the selected or indicated text goes into which field: “Dr.” would go into the Prefix field, “John” in First Name field, “ ” in the Middle Name field, “Doe” in the Last Name field, and “MD” in the Suffix field. The same could be done for other commonly entered fields such as dates, phone numbers, addresses, etc. Of course, manual resolution of the different names and separate selection and entry into the appropriate element in the entry field 106 may also be implemented.

In one embodiment the RDCO system may intelligently select data for data entry. For example if a user clicks on the screen between the “o” and “h” of “John”, the RDCO system may “look” at the information near the click and determine that the text clicked is part of a name. The RDCO system may automatically select the entire name, or auto-format the name text as described above. Other examples of intelligent selection include clicking on part of an image to select the entire image, double clicking anywhere on the page to collect a screenshot etc. Essentially any indication with the selecting device can be intelligently programmed to create certain actions in certain environments. This behavior can be set by preferences in the customized template or automatically performed and can be implemented using known techniques by skilled programmers.

Refer now to FIG. 3. After the user has finished entering data with selecting device 202, a corresponding data presence indicator, check mark 108 may be displayed to indicate that the user has added data to the Specialty field. The user may then review the data item, for example, by hovering the selecting device over, or clicking, button 202 and viewing the entered data item in such display tools as a balloon or popup window 302. The user might also be given the option to deselect the check mark 108, for example, by double or right clicking, to undo and later re-do the entered data item. This may be because the user finds the entry to be incorrect, or simply wishes some other entry. For example, if Dr. Doe has more than one specialty, the user may wish to choose to store a different one instead of the one first selected. Data can be re-entered by repeating these steps and the new data can be viewed in the same manner that the originally entered data was viewed. As one option (not shown), the RDCO system frame 102 could include a button such as “Commit” or “Confirm” to indicate that she accepts the data that has been entered into the various fields and wishes to move on to a different frame 104. Depending on how the database is implemented, this could also signal that the captured data is to be moved from a local buffer to actual inclusion in the database. If the user is so privileged, she may also be allowed to view the data on the Report tab.

FIG. 4 shows an example of entering an image data item into the RDCO system. In this example, the user has selected area 402, which includes an image. The user can then click the data label button 202, labeled “Image” to enter the image data into the RDCO system, or use any other option for association of the data with the entry field, such as dragging-and-dropping, etc. The image may be entered in an appropriate format including TIF, JPEG, GIF, PNG, Bitmap, etc. Clicking on part of an image can be formatted to select the entire image.

FIG. 5 shows how image data can also be reviewed in the same way text data can be reviewed, as in pop-up window 502. If the user is so privileged, they can also view the data on the Report tab.

FIG. 6 shows how a researcher can collect information, not native to the web page or application but relevant to the research—user entered information. In this example, the user has selected text, in this case Zip code information, in form field 128. Cursor 602 shows that the form field has been selected. After selecting the form field, the user uses selecting device 202 to select the “Import/Insert” button. When the “Import/Insert” button is selected, the researcher may then be asked to create a label or find a file, and, data from inside form field 128 is then entered into the RDCO system with the appropriate label associated with a corresponding database field, which may be created in any known manner.

Although a simple text box field 128 is shown here, other form field data can be entered into the RDCO system in a similar manner. In some form field types, such as checkbox, radio button, pull-down menu or other similar type of form field, the user may be able to click near the form field, or outline the form field using the selecting device. Alternatively, the user may select the entry mechanism, in this example the “Add new” button first, which could then trigger a list or menu of the various form fields in the page for the user to select. Additionally, the user may want to store the data from more than one form field and this option is also made available. Possible form field types might include text, password, hidden fields, text area, date, etc., or the current state of such graphical tools as a check box, radio button, drop-down menu, etc. Form field data could also be created at a “Create new template” phase so that the researcher indicates for the report reader other custom conditions.

FIG. 7 shows an example of collecting a screenshot. A “Print Screen” function may be collected automatically in the background, or by a user indicating which portion of the screen to copy, using, for example, a “Screenshot” button as shown in FIG. 7. In this example a screenshot is taken when the user clicks the selecting device 202, “Screenshot, after which a representation of the screenshot collected is shown in pop-up window 702 when the user hovers over, or clicks, the “Screenshot” button. If the user is so privileged, they can also view the data on the Report tab.

Many programs such as Microsoft Word include utilities that enable selection and importation of external data into a current document. For example, one can import an image file into a text document or copy-and-paste text from one document into another by copying it to the system “Clipboard” and then pasting it from there into the desired document. A similar feature may be included in the RDCO system to enable importation into a database field from a source other than the immediately active web screen, such as from a different screen open in the same browser, a different document opened in a different program, or even an external file. The data can then be given an appropriate label as mentioned above, whereupon a corresponding icon/button could be added to the screen area 106. The underlying database may then have a new field added using known methods and the current template could be adjusted. Such alteration of the template would however, preferably require a proper privilege level for the current user. In this case, the user could, for example, select the “Import/Insert” button in the area 106, which could then either automatically accept whatever is currently in the Clipboard as its entry (similar to a common “Paste” feature) or it could then activate and display a window through which the user specifies a file (such as an image file) to be associated with the field. To ensure localized completeness of the database, the actual file data itself is preferably entered and associated with the field, but it would also be possible for a link or file name to be the entry as long as this will reliably lead to the desired data.

Importation of external information into the database entry of a current, but different, source might lead to lack of associativity of database entries with the current web page. In many cases, this will be acceptable—such externally retrieved data could be simply treated as one of the “Notes”, with no special label or need to alter the data structure of the underlying database. It would also be possible, however, always to store the identifier of the source (such as the file name, URL, etc.) along with any such imported data.

Data insertion from a Clipboard or the like need not be only from an external source One other way for a user to select a portion of the displayed screen as data to be stored as an image would be to activate a utility such as the “Snipping Tool” included along with the Windows 7 operating system—using the tool, the user could select the desired portion of the screen area 104 (FIG. 1) and then “paste” it into the button of the area 106. In essence, “snipping” would therefore simply be another form of “selection”, creating an image.

Consider now sample screens for the designer or customer/designer user type. FIG. 8 shows screen 800 of one possible embodiment of the RDCO system. This screen represents what a customer/designer user type might see after logging in to the RDCO system. User name 802 is shown in the upper left and tabs 804 indicate, and allow the user to choose among, different areas of the customer/designer interface to the RDCO system. In this example these tabs represent the “Manage templates”, “Manage users”, “Manage reports” and “Manage projects” sections.

Screen 800 shows the user in the “Manage templates” section. The user has the option of creating a new template from scratch, from a pre-existing template or to edit a pre-existing template. Other template management tools may be presented here.

FIGS. 9A & 9B show example screens of how a customer/designer can create a new template from a pre-existing template or from scratch, or by editing an existing template. In the pre-existing example, the user has chosen the template “Find the right doctor/dentist”. AVAILABLE FIELDS window 902 lists some of the form field types available to the user. Other pre-configured field types are also listed here. TEMPLATE FIELDS window 904 shows the fields that have been chosen for the current template. Automatic fields within the window, shows some of the fields that are collected automatically by the RDCO system. The user may be able to drag and drop the fields from one window to another, or the user may use indicators 908 to move fields from one window to another. In this way, the user can fully customize the data collected for the project. The user may also choose to have more than one field of a certain type in the project. For example, the user may want to collect two different form fields such as a radio button and a list box.

FIG. 10 shows an example of how a customized template can be configured on a more detailed level. This screen shows how the individual fields can be further defined, including whether they are required or optional, or if fields are dependent on another field. For example, the user may not want a field to show up unless a response is found or the response to another field is a particular response or one of a group of particular responses. Or, the user may not want to mark a particular field as required unless the response to another field is a particular response of one of a group of particular responses. On this screen, column 1002 shows whether a field in field list 1006 is required. Column 1004 allows the user to identify whether a field depends on another field. Pull-down menu 1008 lists the available fields used to define dependence as configured by the user (response criteria is not shown). The Add new button brings the user back to FIG. 9, should she discover she is missing a field while in FIG. 10.

FIG. 11 shows an example screen of how the customer/designer of a template can give different users access to the template. The customer/designer is shown a list of possible users 1102, and can select which users have access, and/or create a new user.

FIG. 12 shows an example screen of how a customer/designer can manage users under tab 1202. Here a customer/designer can edit, delete or add a new user using edit links 1206, delete links 1204, and add new user link 1208 respectively.

FIG. 13 shows an example screen of how a new user can be added. The customer/designer can further identify what kind of access and what privileges each user has. For example, some users may be given research access, to collect research data, while others may be given report access, to view the research report. Users may have more than one type of access and access may differ depending on templates or projects. User types can be assigned using pull-down menu 1302. User types can also be managed, and custom user privileges set, using other tools (not shown).

FIG. 14 shows an example screen of how a customer/designer can manage reports under tab 1402. Here a customer/designer can create a custom report, create a report from a template, or edit a report style. Pull-down menu 1404 shows an example of report types available from templates. Some of these reports may be provided with the RDCO system and some may be created by the user.

FIG. 15 shows an example report screen that a customer/designer is reviewing and a report reader might see. In this example, the data is presented in a spreadsheet, or chart, format. Spreadsheet 1502 shows the project data and can be configured in any way that a standard spreadsheet can be configured, including sorting, searching, hiding data etc. Depending on the data type, some of the fields may show the actual data, and some of the fields may provide a link to the data. Images and larger data may be represented by thumbnails with links to more detail, or larger images. If needed, a report editor could be available to reorganize data after it is reported.

FIG. 16 shows an example screen of how a user can manage projects under tab 1602. Here a customer/designer can create a new project from scratch, create a new project from a pre-existing project or edit a project respectively.

FIG. 17 shows an example screen of how a customer/designer can create a project from scratch. In the example, AVAILABLE TEMPLATES window lists the templates available to the user to be assigned to a new project. PROJECT TEMPLATES window shows the templates that have been chosen for the project.

Reports may also involve exporting data, including exporting for other applications, exporting in Comma-Delimited File Format, Field-Delimited File Format, Microsoft Excel File Formats, Tab-Delimited File Format, XML File Format and other formats.

Reports can be viewed on the internet, in an application, on a computer, tablet, phone, or any other appropriate device.

The RDCO system may operate over the internet and/or other network. The system may be client-server based or web-based or application-based. Devices which can access the system include computers, phones, tablets, personal digital assistants and any other device with the hardware and software necessary to view and/or use the RDCO system.

The computing device on which the RDCO system is implemented may include a central processing unit, memory, input devices (e.g., keyboard and pointing devices), output devices (e.g., display devices), and storage devices (e.g., disk drives). The memory and storage devices are computer-readable media that may contain instructions that implement the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

In the example embodiment illustrated in FIGS. 1-17, it is shown that the RDCO system is accessed online through entry of the proper URL such as www.researchdatacollectorganizer.com and the site of interest is also an online source, illustrated as FindAGoodDoc.com. In other words, in the illustrated example, not only is the research being done in web sites, but the RDCO system is accessed and run through the internet, such as being an application in the “cloud” or at least remotely. This is only one possibility for implementing various aspects of the invention: In other implementations, either or both of these two “parts”—the active data collection source, illustrated in FIG. 1 as frame 104, and the RDCO data collection and organization system illustrated as frame 102, could be implemented either remotely or locally.

The illustrated configuration is therefore a “remote-remote” configuration inasmuch as the RDCO system is being accessed and operated primarily, and the data source is accessed and retrieved (for example as HTML code and linked files) over a network such as the Internet, even though the user interacts with both on her local computer. Such a configuration will be particularly advantageous in situations where the user is doing research using a low-capacity device such as a smart phone, although it is of course not limited to such situations. All four “RDCO/source permutations” are possible, however: remote/remote, local/local, local/remote and remote/local.

Consider a “local/local” or “local/remote” configuration. In such a case, the data capture and/or storage components of the RDCO system could be installed on the user's computer as an application or as an agent for later communication with and uploading (or possibly local storage) of collected data. This local application/agent could be launched in any conventional manner, whereupon template creation can be carried out as described above. The user could then open the data source, either as a locally stored file (local/local operation), or by accessing a web site (local/remote) as above, which can be presented as a frame within the RDCO system frame and searched as described above with reference to FIGS. 1-15. If the database is implemented locally, collected data can be stored as above, with no need (but with the option) for uploading to any “cloud” service or remote server; instead, the data can be sent to the local database, which may then even be implemented as a component of the RDCO system itself.

A “local/remote” or “local/local” configuration, or combination of these two, might be preferred by organizations that often carry out large-scale data collection and research projects, especially if they, for reasons of confidentiality and security, prefer not to store their research results outside the organization itself. In other words, if a group of users want to use the RDCO system often, or when not connected to the internet, they may prefer to install and run a copy of the RDCO system as a resident application. As one hypothetical example, a law firm might often have infringement projects and wish to research online materials such as the infringer's online information (to look for evidence of infringement), as well as case law presented by services such as Westlaw and patent texts such as on the USPTO web site. Of course, even in situations where some data is sourced via the internet, other data research could be based on locally stored files such as drafts of briefs or memos. The database that stores the accumulated research results could then be implemented on the firm's own server, or stored and later uploaded, for example, as a batch, to a secure server, including a virtual “cloud” server that includes a database.

In a “remote/local” configuration, the RDCO system and associated database are accessed and run via the network, but at least some data source is on the user's local computer. Such a configuration might be advantageous for users who expect to do few projects, and so do not wish to have to install any software locally, but who have a large number of locally stored documents that they would like to examine and compile information from. Coupled with conventional mechanisms for optical character recognition, such a configuration would allow the users to selectively and efficiently extract useful information from the documents and store/archive it in electronic, searchable form.

Of course, many implementations of the invention may well be a “hybrid” of these different configurations, with some local data sources to be researched and other sources accessible as web sites, and possibly with local, temporary buffering of collected data (making it easier to change before committing it to inclusion in the database) before sending it to the database in the remote server.

FIG. 18 illustrates a general system that can be used to implement various embodiments of the invention. FIG. 18 illustrates one user-level system 1800 that interacts with a RDCO server 1900 over a network (such as the internet, a telephone network, etc.), but this is merely for the sake of simplicity. The different user roles (such as designer, researcher, report reader, etc.) may have separate user-level systems, and in some implementations some of the user roles may coincide; indeed, in some implementations (such as the “local/local” embodiment), the user-level system 1800 and the RDCO server 1900 may be found within a single entity and even a single computer, with no need for an external network connection at all. For some roles, not all of the components of the user system 1800 as shown in FIG. 18 will be necessary, as one will understand from the description of the various user roles above, for example a report reader may not need an input/selection device.

At the user level, system hardware 1810 includes one or more processors (CPUs) 1811 and one or more volatile and non-volatile memory devices 1812, which may be used to implement the local data buffer if this design feature is chosen. The system hardware will typically also include I/O cards and controllers 1814 as needed to communicate with and control such input and selection devices or routines 1852 such as a mouse (or trackball, joystick, etc.), keyboard (or speech recognizer, etc.), touch-screen sensor, etc., as output devices such as a display device 1855, which may be a separate monitor, incorporated as, for example, a tablet or smart phone touch-screen display, etc.

System software 1820 will typically include some type of operating system (OS) 1822 and various drivers 1824 that are used for software control of physical devices; note that the drivers 222 are typically installed in the OS itself. A graphical user interface (GUI) controller 224 is also often an integral component of the OS.

An application/user software layer 1830, which typically runs at the user level, is usually installed to run on the system software 1820, although many applications, especially on virtualized platforms, nowadays are executed from a remote server in an arrangement often called “cloud computing”. There are of course countless applications and it is these programs whose operation is most visible to users. One application is a browser 1885, which, as is well known, is used to retrieve, interpret, display and interact with content accessed over the Internet.

An RDCO software module 1880 is included in the user-level system 1800. This module 1880, which may be programmed using known techniques, carries out the various tasks described above, such as transferring for display the selected template, interpreting user selections and commands (which she may enter using the input/selection mechanism 1852), sensing, accepting and formatting data that the user has selected and entered, and mapping, exporting, encoding or presenting schema systems for communicating with the RDCO server 1900, either via the network 2000 or internally if this component is included in the user system 1800. As mentioned above, the RDCO module may be implemented as a typical application, or as an agent.

The RDCO server 1900, or equivalent user-level components, includes a validation module 1910 to perform such tasks as identifying which user is connecting with the RDCO server and what privilege level the user has so as to prevent unauthorized accesses and edits. A template module 1920 stores the various templates, and interacts with the designer (who will be at some user level connected to the server 1900) to create new ones. A data extraction module 1940 evaluates records received from the RDCO component 1880, which in turn will have got them from users' (in particular, researchers) interaction with selected data source(s) and a current template. A field association module 1950 then ensures that the data in the various fields is in the proper format (if this isn't already done by the RCDO module 1880) and enters it into the appropriate field and or record of the database 1960, corresponding to the current project. A presentation module 1970 is preferably included to retrieve requested database records and present them for viewing and analysis by the user, such as the report reader.

It is not necessary for there to be only a single database 1960; databases could be distributed based on size or project demands, or hosted in the “cloud” and distributed as part of the business model. It is also advantageous to store the research data in more than one database, for both security and redundancy functions. One instance where this might be desirable is when one's database is highly sensitive to hacking (such as a law firm's or government agency) and a copy would be made and periodically compared with the local server copy to ensure that data had not been tampered with. Essentially a copy—is hosted remotely, such as in “cloud storage”, not only for back-up, but also to ensure ongoing data integrity.

I claim:

1. A method for collecting and organizing data comprising:
sensing, by a data-collection software module running within a user device, a selection by a user of at least one data item displayed by user-layer software;
displaying an input template;
sensing an indication by the user of selection, for each selected data item, of a data label of the displayed input template;
automatically associating each selected data item with a respective database field corresponding to the data label;
upon occurrence of a trigger event, sending data to the database for storage corresponding to the selected data item(s) according to their respective database fields
in which:
the data-collection software module runs simultaneous with the user-layer software and operates between the user-layer software and the database; and
the data-collection software module is presented to the user as a graphical user interface.

2. A method as in claim 1, in which the network is the Internet.

3. A method as in claim 1, in which the user device is a telephone.

4. A method as in claim 1, in which the user device is chosen from the group: telephone, personal data assistant, and tablet computer.

5. A method as in claim 1, in which the user-layer software is a browser and the data item is displayed as a portion of a web page received over a network and rendered by the browser.

6. A method as in claim 1, further comprising displaying the input template only upon user selection of the data item, such that the data-collection software module otherwise runs substantially invisible to the user.

7. A method as in claim 1, in which the database is located remote from the user device.

8. A method as in claim 1, in which the database is co-located with the user device.

9. A method as in claim 1, further comprising providing the data-collection software module as a network-accessed utility functionally overlaid on the user-layer software.

10. A method as in claim 9, further comprising running the user-layer software as a frame within the data-collection software module.

11. A method as in claim 1, in which the data item may have an arbitrary format and the database field is configured to store data of the corresponding format.

12. A method as in claim 11, in which the arbitrary format includes an image format.

13. A method as in claim 11, in which the arbitrary format includes an indication of the state of an on-screen graphical input tool.

14. A method as in claim 1, in which the trigger event is the sensing of the indication by the user of selection of the data label and completion of the automatic association of the selected data item with the respective database field.

15. A method as in claim 1, further comprising buffering the data to be exported until occurrence of the trigger event.

16. A method as in claim 15, in which the trigger event is a user-initiated input action.

17. A method as in claim 15, in which the trigger event is that a pre-determined time period has elapsed.

18. A method as in claim 1, further comprising automatically associating at least one system data item with a respective database field independent of user selection.

19. A method as in claim 18, in which the at least one system data item is a URL of a current web page displayed by the user-layer software.

20. A method as in claim 18, in which the at least one system data item is system time.

21. A system for collecting and organizing data comprising:
a data-collection software module running within a user device and provided:
for sensing selection by a user of at least one data item displayed by a user-layer software entity;
for generating within the user device an input template;
for sensing an indication by the user of selection, for each selected data item, of a data label of the displayed input template;
for automatically associating each selected data item with a respective database field corresponding to the data label; and
upon occurrence of a trigger event, for sending data to the database for storage corresponding to the selected data item(s) according to their respective database fields
in which:
the data-collection software module runs simultaneous with the user-layer software and operates between the user-layer software and the database; and
the data-collection software module is presented to the user as a graphical user interface.

22. A system as in claim 21, in which the network is the Internet.

23. A system as in claim 21, in which the user device is a telephone.

24. A system as in claim 21, in which the user device is chosen from the group: telephone, personal data assistant, and tablet computer.

25. A system as in claim 21, in which the user-layer software is a browser and the data item is displayed as a portion of a web page received over a network and rendered by the browser.

26. A system as in claim 21, in which the data-collection software module is further provided for displaying the input template only upon user selection of the data item, such that the data-collection software module otherwise runs substantially invisible to the user.

27. A system as in claim 21, in which the database is located remote from the user device.

28. A system as in claim 21, in which the database is co-located with the user device.

29. A system as in claim 21, further comprising providing the data-collection software module as a network-accessed utility functionally overlaid on the user-layer software.

30. A system as in claim 21, in which the data item may have an arbitrary format and the database field is configured to store data of the corresponding format.

31. A system as in claim 30, in which the arbitrary format includes an image format.

32. A system as in claim 30, in which the arbitrary format includes an indication of the state of an on-screen graphical input tool.
